(19) United States
(12) Patent Application Publication
(10) Pub. No.: US 2023/0018984 A1
(43) Pub. Date: Jan. 19, 2023

(54) Automatic Leakage Detection Line

(71) Applicant: DongGuan City TuoCheng Industries Co., Ltd., Dongguan City (CN)

(72) Inventors: Tao Zhang, Dongguan City (CN); Juntuo Yang, Dongguan City (CN)

(21) Appl. No.: 17/824,022

(22) Filed: May 25, 2022

(30) Foreign Application Priority Data
Jul. 15, 2021 (CN) 202121615602.X
Apr. 21, 2022 (CN) 202220938051.9

(51) Int. Cl. H01B 11/18; H01B 11/00; H01B 7/02

(52) U.S. Cl. CPC H01B 11/1895; H01B 11/002; H01B 7/0225

(57) ABSTRACT

This invention relates to the technical field of cables and, in particular, to an automatic leakage detection wire, which comprises an insulating protective layer, a plurality of core wires, a detection wire and an additional signal wire, and the detection wire is electrically connected with the additional signal wire. The detection wire and the additional signal wire are all connected to an external signal detection device; the core wire includes a conductor group and a first insulating layer covering the outer periphery of the conductor group; the detection wire, the additional signal wire, and a plurality of the cores. The wires are all wrapped in the insulating protective layer. The automatic leakage detection line provided by the invention can carry out an early warning through the detection line and an additional signal line, thereby reducing the accident risk caused by the damage of the automatic leakage detection line.

### FIELD

The present invention relates to the technical field of cables and, in particular, to an automatic leakage detection line.

### BACKGROUND

The cable is an important connection device for signal transmission or power supply. Although the current cables have relatively high durability and are less affected by external influences, the cables will inevitably be damaged, broken, and broken during long-term use. However, since the outside of the cable is provided with an insulating protective layer, it is not easy to detect the damage to the internal structure of the cable, resulting in the failure to repair the cable in time, which is likely to cause damage to electrical facilities, etc.

### SUMMARY OF THE DISCLOSURE

Aiming at the problems presented in the prior art, this invention provides an automatic leakage detection line. By arranging the detection line and the additional signal line, when the detection line and the additional signal line are broken during use, the leakage between the detection line and the additional signal line is caused. If the connection is disconnected, the external signal detection device can detect it in time, and the staff can repair it in time.

To solve the foregoing problems, the present invention provides an automatic leakage detection wire, comprising an insulating protective layer and several core wires, wherein the automatic leakage detection wire is characterized in that: the automatic leakage detection wire also includes a detection wire and an additional signal wire, the detection wire is electrically connected with the additional signal wire, and the detection wire and the additional signal wire are electrically connected. They are all signal-connected to an external signal detection device; the core wire includes a conductor group and a first insulating layer wrapped around the outer periphery of the conductor group; the detection wire, the additional signal wire, and a number of the core wires are all wrapped around the insulation within the protective layer.

Preferably, the detection wire is a bare copper wire.

Preferably, the automatic leakage detection wire further includes at least one detection signal layer, each of the detection signal layers is wrapped with at least one of the core wires, and the detection wire is signally connected to all the detection signal layers.

Preferably, the detection signal layer is a synthetic graphene layer.

Preferably, the outer periphery of the additional signal line is provided with a third insulating layer.

Preferably, the outer periphery of the core wire located outside the detection signal layer is covered with a shielding signal layer.

Preferably, the shielding signal layer is a synthetic graphene layer.

Preferably, the conductor set includes several wires, and the radial cross-section of the wires is circular.

Preferably, the wires are copper wires, enameled copper wires or nickel-clad copper wires.

### BRIEF DESCRIPTION OF THE DRAWINGS

FIG. 1 is the structural representation one of embodiment one of the present invention;

FIG. 2 is the structural representation two of the first embodiment of the present invention;

FIG. 3 is the structural representation of the second embodiment of the present invention; and

FIG. 4 is a schematic structural diagram of a plurality of first insulating layers and conductor groups wrapped in a detection signal layer according to Embodiment 2 of the present invention.

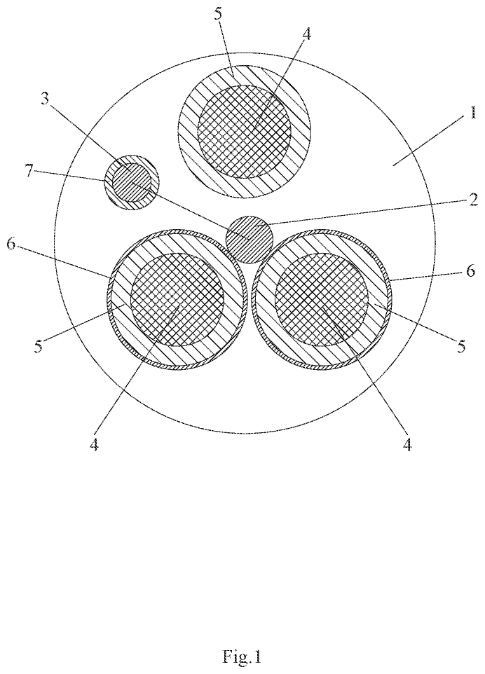

Reference numerals in FIGS. 1 to 4 include:

1—insulation protection layer, 2—detection line, 3—additional signal line, 4—conductor group, 5—first insulation layer, 6—detection signal layer, 7—third insulation layer, 8—shield signal layer.

### DETAILED DESCRIPTION

In order to enable your examiners to further understand the structure, features In order to facilitate the understanding of those skilled in the art, the present invention will be further described below with reference to the embodiments and the accompanying drawings, and the contents mentioned in the embodiments are not intended to limit the present invention. The present invention will be described in detail below in conjunction with the accompanying drawings.

### Embodiment 1

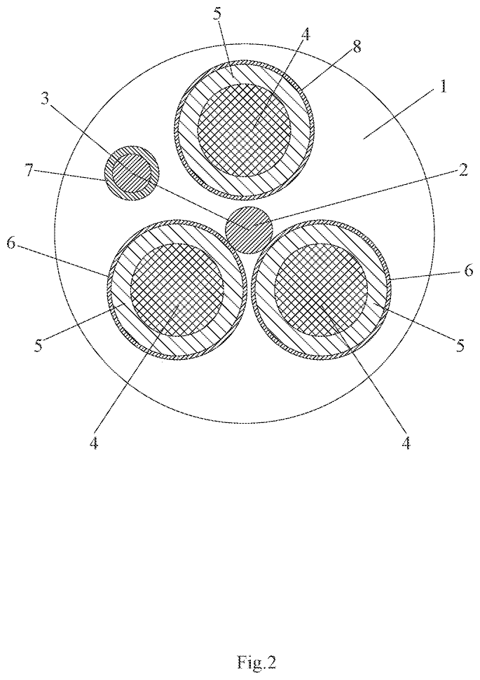

An automatic leakage detection line provided in this embodiment, as shown in FIG. 1 and FIG. 2. The automatic leakage detection line includes an insulating protective layer 1 and several core wires, and also includes a detection line 2 and an additional signal line 3. The detection line 2 and the additional signal line 3. The wire 3 is electrically connected, and the detection wire 2 and the additional signal wire 3 are both signal-connected to an external signal detection device; the core wire includes a conductor group 4 and a first insulating layer 5 covering the periphery of the conductor group 4. The detection wire 2, the additional signal wire 3 and a number of the core wires are all wrapped in the insulating protective layer 1. Optionally, the radial cross section of the wire is circular.

Specifically, as shown in FIG. 1, core wires such as live wire, neutral wire and ground wire are generally set inside an ordinary cable. In this embodiment, a detection wire 2 and an additional signal wire 3 are added. Since the detection wire 2 and the additional signal wire 3 are not. It is used to transmit current and voltage signals, but act as induction. Therefore, the diameter of the detection wire 2 and the additional signal wire 3 is preferably smaller than that of the live wire, neutral wire and other core wires. Therefore, during long-term use, if bending occurs, the detection wire 2 and the additional signal line 3 are broken, causing the connection between the detection line 2 and the additional signal line 3 to be disconnected. At this time, the external signal detection device detects the disconnection signal, and the detection cable of this embodiment is repaired by the staff to check to avoid accidents. In this embodiment, the detection wire 2 and the additional signal wire 3 are used as early warning signals. When the signal between the detection wire 2 and the additional signal wire 3 is disconnected due to breakage or other problems, it means that the core wire of this embodiment is also possible. If there is a problem, it is necessary to notify the staff to carry out maintenance in time, so as to avoid the use of safety problems as soon as possible.

Alternatively, the detection wire 2 in this embodiment is a bare copper wire.

Further, an automatic leakage detection line provided in this embodiment, as shown in FIG. 1, the automatic leakage detection line further includes at least one detection signal layer 6, and each of the detection signal layers 6 is wrapped with at least one of the core wires, the detection line 2 is signal-connected to all the detection signal layers 6. The detection signal layer 6 is preferably a graphene layer.

Specifically, in practice, the detection signal layer 6 is generally wrapped around the live wire and the neutral wire. When the first insulating layer 5 of the live wire or the neutral wire is damaged, the conductor group 4 located in the first insulating layer 5 and the detection signal layer 6 is electrically connected, the conductor group 4 also generates a short-circuit signal with the detection line 2, and the external signal detection device receives the short-circuit signal between the detection line 2 and the conductor group 4, indicating that there is a fault in the current power line, and reminding the staff in time to repair or replace to reduce the probability of electricity accidents.

Further, the outer periphery of the additional signal line 3 is also provided with a third insulating layer 7, as shown in the figure. It is prevented that after the detection line 2 and the additional signal line 3 are disconnected, the connected signal continues to appear due to the contact between the two, resulting in misjudging the internal conditions of the detection cable of this embodiment.

In an automatic leakage detection wire provided in this embodiment, as shown in FIG. 2, the outer periphery of the core wire located outside the detection signal layer 6 is covered with a shielding signal layer 8. Optionally, the shielding signal layer 8 is a synthetic graphene layer.

Specifically, in this embodiment, a shielding signal layer 8 made of synthetic graphene is also provided on the periphery of the core wire where the bottom wire is located, which can not only achieve the effect of shielding, but also achieve the effect of core wire damage detection and signal transmission.

In an automatic leakage detection line provided in this embodiment, as shown in FIG. 1, the conductor group 4 includes several wires, and the radial cross-section of the wires is circular, wherein the wires are copper wires, enameled copper wires or nickel-coated wires.

### Embodiment 2

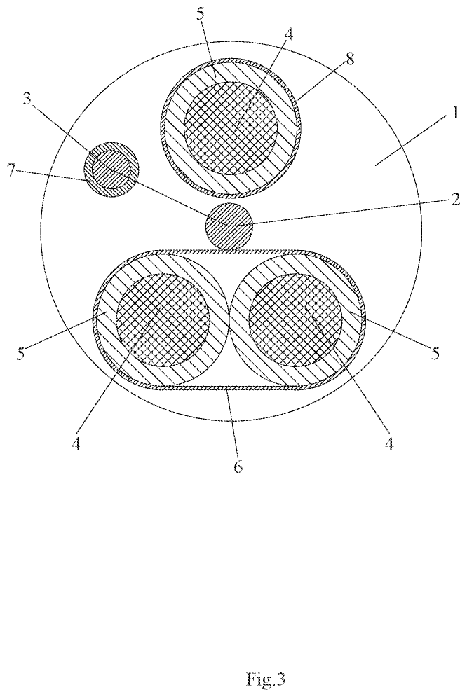

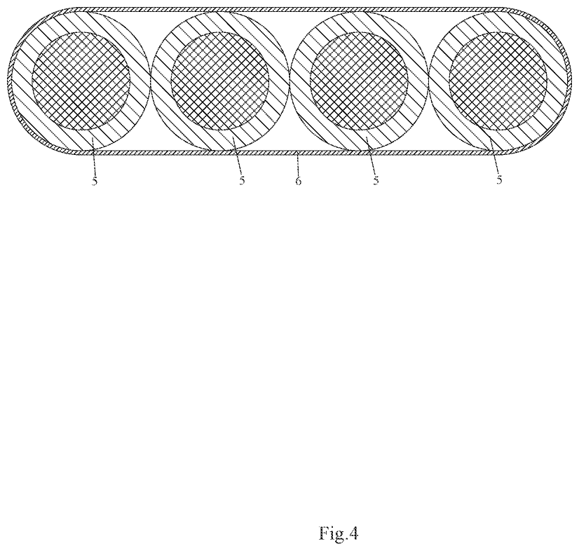

In an automatic leakage detection line provided in this embodiment, as shown in FIG. 3 and FIG. 4, the detection signal layer 6 is wrapped with at least two sets of core wires, and the first insulating layer 5 in the detection signal layer 6 is connected to the detection signal layer 6. The inner wall of the signal layer 6 collides; when the first insulating layer 5 in the detection signal layer 6 is damaged, the detection signal layer 6 is electrically connected to the conductor group 4, and the detection line 2 and the detection signal layer 6 have a signal connect. The conductor groups 4 are preferably provided with at least three groups.

Specifically, as shown in FIG. 3, the outer periphery of each conductor group 4 is covered with a first insulating layer 5 to form a core wire, and several core wires do not interfere with each other, and the detection signal layer 6 in this embodiment It has conductive properties and can transmit signals, so it also belongs to the shielding layer of the core wire. In this embodiment, the detection signal layer 6 is covered with at least two sets of core wires, and the two sets of core wires interfere with each other, and there is at least one contact point between the detection signal layer 6 and the wrapped core wires, in order to wrap the core wire tightly, the structures shown in FIG. 3 and FIG. 4 will appear. The half circle of the core wire can actually conflict with both ends of the detection signal layer 6, so that the detection signal layer 6 can be area to achieve the effect of signal transmission and detection, help to reduce costs. When one or more of the first insulating layers 5 in the detection signal layer 6 are damaged, the conductor group 4 wrapped by the first insulating layer 5 may expose the first insulating layer 5, the conductor group 4 and the conductor group 4. There will be a short circuit between them, and the contact with the detection signal layer 6 will generate a short circuit signal, and then a short circuit signal will also appear with the detection line 2. At this time, the detection signal layer 6 or the detection line 2 will transmit the short circuit signal to the external signal detection device, so that the staff can understand and take timely measures to reduce losses. Compared with coating the detection signal layer 6 on the periphery of each set of core wires, in this embodiment, at least two sets of core wires are arranged in the detection signal layer 6, which can reduce the fabrication material of the detection signal layer 6. As shown in FIG. 4, when there are more than two sets of core wires, the outer periphery of the core wires does not need to cover the detection signal layer 6, so that the manufacturing cost of the detection signal layer 6 can be greatly reduced.

Preferably, the detection signal layer 6 in this embodiment is a synthetic graphene layer, that is, the detection signal layer 6 is made of graphene, and the graphene layer in this embodiment is made by a synthetic method rather than a spraying method.

The above are only preferred embodiments of the present invention, and are not intended to limit the present invention in any form. Although the present invention is disclosed as a preferred embodiment, it is not intended to limit the present Professional and technical personnel, within the scope of the technical solution of the present invention, make some changes or modifications to equivalent examples of equivalent changes by using the technical content disclosed above, provided that they do not depart from the content of the technical solution of the present invention, according to the present invention. The invention technology refers to any simple modification, equivalent change and modification made to the above embodiments, which all belong to the scope of the technical solution of the present invention.

To sum up, the present invention can indeed achieve the above-mentioned functions and purposes, so the present invention should meet the requirements for a patent application, and an application should be filed in accordance with the law.

1. An automatic leakage detection wire, comprising an insulating protective layer and several core wires, wherein the automatic leakage detection wire is characterized in that:
the automatic leakage detection wire also includes a detection wire and an additional signal wire, the detection wire is electrically connected with the additional signal wire, and the detection wire and the additional signal wire are electrically connected and are all signal-connected to an external signal detection device; the core wire includes a conductor group and a first insulating layer wrapped around the outer periphery of the conductor group; the detection wire, the additional signal wire, and a number of the core wires are all wrapped around the insulation within the protective layer.

2. The automatic leakage detection wire as claim 1, wherein it is characterized in that the detection wire is a bare copper wire.

3. The automatic leakage detection wire as claim 1, wherein it is characterized in that the automatic leakage detection wire further includes at least one detection signal layer, each of the detection signal layers is wrapped with at least one of the core wires, and the detection wire is signally connected to all the detection signal layers.

4. The automatic leakage detection wire as claim 1, wherein it is characterized in that the detection signal layer is a synthetic graphene layer.

5. The automatic leakage detection wire as claim 1, wherein it is characterized in that the outer periphery of the additional signal line is provided with a third insulating layer.

6. The automatic leakage detection wire as claim 1, wherein it is characterized in that the outer periphery of the core wire located outside the detection signal layer is covered with a shielding signal layer.

7. The automatic leakage detection wire as claim 6, wherein it is characterized in that the shielding signal layer is a synthetic graphene layer.

8. The automatic leakage detection wire as claim 1, wherein it is characterized in that the conductor set includes several wires, and the radial cross-section of the wires is circular.

9. The automatic leakage detection wire as claim 8, wherein it is characterized in that the wires are copper wires, enameled copper wires or nickel-clad copper wires.
